(19) United States
(12) Patent Application Publication
(10) Pub. No.: US 2005/0055531 A1
(43) Pub. Date: Mar. 10, 2005

(54) Non-volatile memory control device capable of recovering data even when data writing is interrupted

(75) Inventors: Kazuo Asami, Itami-shi (JP); Atsuo Yamaguchi, Tokyo (JP)

Correspondence Address: BURNS DOANE SWECKER & MATHIS L L P, POST OFFICE BOX 1404, ALEXANDRIA, VA, 22313-1404, US

(73) Assignees: Renesas Technology Corp., Tokyo (JP); Renesas LSI Design Corporation, Itami-shi (JP)

(21) Appl. No.: 10/785,102

(22) Filed: Feb. 25, 2004

(30) Foreign Application Priority Data
Sep. 9, 2003 (JP) 2003-317119

(51) Int. Cl. G06F 12/00; G06F 12/08

(52) U.S. Cl. 711/203; 711/103

(57) ABSTRACT

A free page extracting unit extracts a free page of a non-volatile memory. A directory page writing unit writes, to the free page extracted by the free page extracting unit, a directory that includes a logical page/physical page translation table of a page to which updated data are to be written. Further, a data page writing unit writes updated data to the free page extracted by the free page extracting unit. Therefore, even when data updating operation is interrupted, loss of the original data can be prevented, and the data before updating can be recovered.

### BACKGROUND OF THE INVENTION

1. Field of the Invention

The present invention relates to a technique for controlling a non-volatile memory and, more specifically, to a non-volatile memory control device capable of recovering data even when data writing should be interrupted.

2. Description of the Background Art

Recently, memories having large storage capacity have been strongly desired, and therefore, non-volatile memories, flash memories in particular, come to be widely used. Generally, a flash memory consists of a plurality of sectors, and each sector consists of a plurality of pages. In a flash memory, data are erased sector by sector and written page by page.

When the non-volatile memory control device is to update a plurality of data stored in a flash memory through an operation or the like, all the data in the sector to which the updated data are to be stored are erased and thereafter, data such as a result of the operation are written, or data are written to a new page. Japanese Patent Laying-Open No. 7-153284 discloses a related technique.

In the method of controlling a non-volatile semiconductor memory device disclosed in Japanese Patent Laying-Open No. 7-153284, an erasing flag, a valid flag and a logical block address are stored block by block. When data of a logical block are to be rewritten, the corresponding physical block is not immediately erased. First, that the erasure is required is written in the erasing flag, and an unwritten block of which erasing flag and the valid flag indicate no need of erasure and invalidity, respectively, is found. Thereafter, data are written to the thus found block, validity is written to the valid flag, and the block is erased while it is not being accessed.

When a plurality of data stored in a flash memory are to be updated and the sector storing the data to be updated is erased, it is the case that data other than the data to be updated are also erased. Therefore, when the data updating operation should be interrupted by a power failure or the like during the period from data erasure of the sector until updating of the data, data other than those to be updated would also be lost and cannot be recovered.

In the method of controlling a non-volatile semiconductor memory device disclosed in Japanese Patent Laying-Open No. 7-153284, the block is erased while it is not being accessed. Therefore, a low speed erasing operation can effectively be hidden. However, when the data in the block are erased before completion of rewriting of the data in the logical block and updating of the data should be interrupted by a power failure or the like, data other than those to be updated would also be lost and cannot be recovered.

### SUMMARY OF THE INVENTION

An object of the present invention is to provide a non-volatile memory control device capable of recovering original data even when data updating should be interrupted.

Another object is to provide a non-volatile memory control device capable of readily obtaining latest data of a logical page.

A further object is to provide a non-volatile memory control device capable of erasing data in a sector of a non-volatile memory efficiently.

According to an aspect, the present invention provides a non-volatile memory control device for controlling a non-volatile memory in which data are erased sector by sector and data are written page by page, including: an extracting unit extracting a free page of the non-volatile memory; a first writing unit writing, to the free page extracted by the extracting unit, a directory including a table for translating a logical page number of a page to which updated data are to be written to a physical page number; and a second writing unit writing the updated data to the free page extracted by the extracting unit.

Therefore, even when data updating should be interrupted, loss of the original data can be prevented, and therefore, data before updating can be recovered.

According to another aspect, the present invention provides a non-volatile memory control device for controlling a non-volatile memory in which data are erased sector by sector and data are written page by page, including: a first searching unit searching for a directory page including a table for translating a logical page number of a page to which updated data are to be written to a physical page number, a first pointer pointing a directory page to be newly written to, and a second pointer pointing a second latest directory page, and successively searching through directory pages based on the first and second pointers included in the directory pages; a second searching unit referring to the table in the directory page searched out by said first searching unit and searching whether a desired logical page is contained or not; and a reading unit reading, when the second searching unit searched out a plurality of the desired logical pages, data from a physical page that corresponds to the logical page included in the latest table.

Therefore, data of the latest logical page can readily be obtained.

According to a further aspect, the present invention provides a non-volatile memory control device for controlling a non-volatile memory in which data are erased sector by sector and data are written page by page, including: an extracting unit referring to a directory page including a table for translating a logical page number of a page to which updated data are to be written to a physical page number and a pointer pointing the oldest sector and extracting a logical page included in the oldest sector; a searching unit searching whether a logical page identical with the logical page extracted by the extracting unit is included in any other sector; and an erasing unit erasing the oldest sector, when it is determined by the searching unit that identical logical pages are fully included in another sector.

Therefore, it becomes possible to efficiently erase data of a sector of the non-volatile memory.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram representing an exemplary configuration of a non-volatile memory control device in accordance with a first embodiment of the present invention.

FIG. 2 is a block diagram representing a schematic configuration of a microcomputer 32 shown in FIG. 1.

FIG. 3 shows an exemplary map of a non-volatile memory in accordance with the first embodiment of the present invention.

FIG. 4 is a block diagram representing a functional configuration of a non-volatile memory control device in accordance with the first embodiment of the present invention.

FIG. 5 is a flow chart representing process steps performed by the non-volatile memory control device in accordance with the first embodiment of the present invention.

FIG. 6 shows an exemplary map of a non-volatile memory in accordance with a second embodiment of the present invention.

FIG. 7 is a flow chart representing process steps performed by the non-volatile memory control device in accordance with the second embodiment of the present invention.

FIG. 8 shows an exemplary map of a non-volatile memory in accordance with a third embodiment of the present invention.

FIG. 9 is a block diagram representing a functional configuration of a non-volatile memory control device in accordance with the third embodiment of the present invention.

FIG. 10 is a flow chart representing process steps performed by the non-volatile memory control device in accordance with the third embodiment of the present invention.

FIG. 11 shows an exemplary map of a non-volatile memory in accordance with a fourth embodiment of the present invention.

FIG. 12 shows an exemplary map of a non-volatile memory in accordance with a fifth embodiment of the present invention.

FIG. 13 is a block diagram representing a functional configuration of a non-volatile memory control device in accordance with the fifth embodiment of the present invention.

FIG. 14 is a flow chart representing process steps performed by the non-volatile memory control device in accordance with the fifth embodiment of the present invention.

FIG. 15 shows an exemplary map of a non-volatile memory in accordance with a sixth embodiment of the present invention.

FIG. 16 is a block diagram representing a functional configuration of a non-volatile memory control device in accordance with the sixth embodiment of the present invention.

FIG. 17 is a flow chart representing process steps performed by the non-volatile memory control device in accordance with the sixth embodiment of the present invention.

FIG. 18 shows an exemplary map of a non-volatile memory in accordance with a seventh embodiment of the present invention.

FIG. 19 shows an exemplary map of a non-volatile memory in accordance with an eighth embodiment of the present invention.

FIG. 20 shows an exemplary map of a non-volatile memory in accordance with a ninth embodiment of the present invention.

FIG. 21 shows an exemplary map of a non-volatile memory in accordance with a tenth embodiment of the present invention.

FIG. 22 shows an exemplary map of a non-volatile memory in accordance with an eleventh embodiment of the present invention.

FIG. 23 is a flow chart representing, in detail, the process of step S9″ by a non-volatile memory control device in accordance with a twelfth embodiment of the present invention.

### DESCRIPTION OF THE PREFERRED EMBODIMENTS

(First Embodiment)

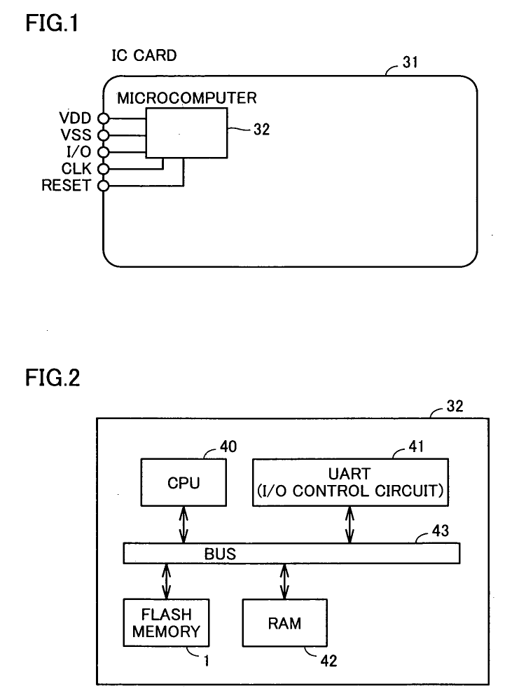

FIG. 1 is a block diagram representing an exemplary configuration of a non-volatile memory control device in accordance with a first embodiment of the present invention. The non-volatile memory control device is provided in an IC (Integrated Circuit) card 31 and includes a microcomputer 32. At a connector portion of the IC card, a power supply (VDD) terminal, a ground (VSS) terminal, an I/O (input/output) terminal for inputting and outputting data, control signals and the like, a clock (CLK) terminal, and a reset (RESET) terminal for resetting microcomputer 32 are provided, which terminals are connected to microcomputer 32. Microcomputer 32 is also referred to as the non-volatile memory control device.

FIG. 2 is a block diagram representing a schematic configuration of microcomputer 32 shown in FIG. 1. Microcomputer 32 includes a CPU (Central Processing Unit) 40 for overall control of microcomputer 32, an I/O control circuit such as an UART (Universal Asynchronous Receiver- Transmitter) 41, and a RAM (Random Access Memory) 42. CPU 40 is connected to flash memory 1, UART 41 and RAM 42 through a bus 43, and controls IC card 31 while inputting/outputting data. Though the present embodiment will be described assuming that flash memory 1 is provided within microcomputer 32, flash memory 1 and microcomputer 32 may be formed on separate chips.

When a reset signal is input through the RESET terminal, CPU 40 starts an operation in synchronization with a clock signal input through the CLK terminal. By way of example, CPU 40 loads a control program stored in flash memory 1 to RAM 42, and executes the control program to realize the control of non-volatile memory 1 as will be described later.

UART 41 transmits/receives data to and from the outside through the I/O terminal. Receiving external serial data, UART 41 converts the serial data to parallel data, outputs an interruption signal to CPU 40, and requests reading of data. When CPU 40 receives an access request from an application through UART 41, CPU 40 performs an operation, which will be described later, in response to the access request. Receiving transmission data from CPU 40, UART 41 converts the transmission data to serial data, and externally transmits the serial data.

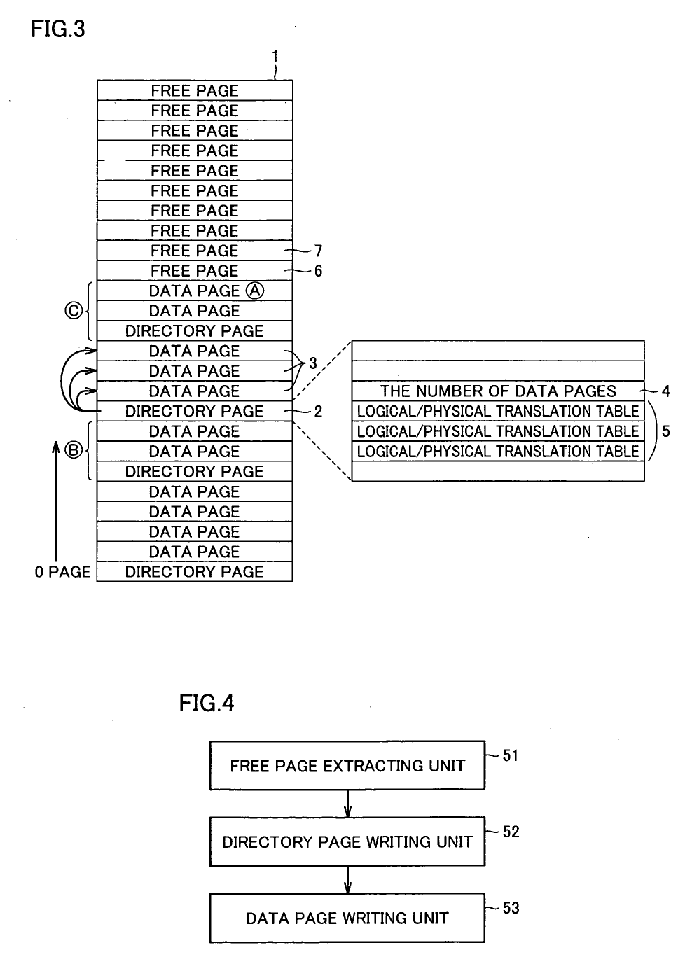

FIG. 3 shows an exemplary map of a non-volatile memory in accordance with the first embodiment of the present invention. The non-volatile memory control device manages non-volatile memory 1 by dividing the same into pages as a unit of writing. When data such as a result of operation is to be written to non-volatile memory 1, the non-volatile memory control device translates a logical page number included in an access from an application to a physical page number.

A directory page 2 includes the number of data pages 4 to which data is to be written, and a logical/physical translation table 5 for translating the logical page number to a physical page number. When updating data are to be written to data pages 3 of non-volatile memory 1, the non-volatile memory control device writes to directory page 2 the number of data pages 4 and the logical/physical translation table 5 corresponding to each of the data pages 3.

FIG. 4 is a block diagram representing a functional configuration of a non-volatile memory control device in accordance with the first embodiment of the present invention. The non-volatile memory control device includes a free page extracting unit 51 extracting a free page of non-volatile memory 1, a directory page writing unit 52 writing contents of directory page 2 to the free page, and a data page writing unit 53 writing contents of data page 3 to the free page.

FIG. 5 is a flow chart representing process steps performed by the non-volatile memory control device in accordance with the first embodiment of the present invention. First, free page extracting unit 51 extracts a free page and makes the same as a directory page (S1). Page writing is performed in order starting from 0th page, and therefore, by making a reference to the number of data pages in the directory page of 0, it is possible to detect the storage location of the next directory page. This process is repeated and when it is determined that the next directory page does not have any data stored therein, that page is considered to be the first free page, and following pages are all extracted as free pages. In the example of FIG. 3, pages 6 and the following are all free pages, and free page 6 serves as a directory page.

Thereafter directory page writing unit 52 writes the number of data pages 4 to directory page 2 (S2). Then, directory page writing unit 52 writes to directory page 2 a logical/physical translation table 5 for translating a logical page number from an application to a physical page number (S3).

Finally, data page writing unit 53 writes contents of the data page including the result of operation, starting from free page 7 that follows the directory page (S4), and the process is thus complete.

By way of example, assume that the directory page and data pages indicated by (B) of FIG. 3 are updated and written to the portion (C) of FIG. 3, and that the non-volatile memory control device receives an instruction for reading the contents of data page (A). Here, the non-volatile memory control device refers to the number of data pages in the directory pages, successively extracts directory pages and reads contents therefrom. In the logical/physical translation table in the directory page at (B) and in the logical/physical translation table in the directory page at (C), the logical page number of which reading instruction has been received is stored. Therefore, reference is made to the logical/physical translation table in the directory page at (C) that has been newly written, and the data is read from the data page (A) of the physical page number.

As described above, in the non-volatile memory control device in accordance with the present embodiment, the contents of the directory page and of the data page are successively written to free pages. Accordingly, even when an updating operation should be interrupted by a power failure or the like, loss of the original data can be prevented, and the data before updating can be recovered.

Further, as the non-volatile memory control device manages data writing page by page, it becomes possible to effectively utilize free areas of the memory.

(Second Embodiment)

Exemplary configuration of the non-volatile memory control device in accordance with the second embodiment of the present invention is similar to that of the non-volatile memory control device in accordance with the first embodiment shown in FIGS. 1 and 2. Functional configuration of the non-volatile memory control device in accordance with the second embodiment of the present invention is similar to that of the non-volatile memory control device in accordance with the first embodiment shown in FIG. 4, except for the function of free page extracting unit 51. Therefore, detailed description of overlapping configuration and function will not be repeated. In the present embodiment, the free page extracting unit will be denoted by the reference character 51′.

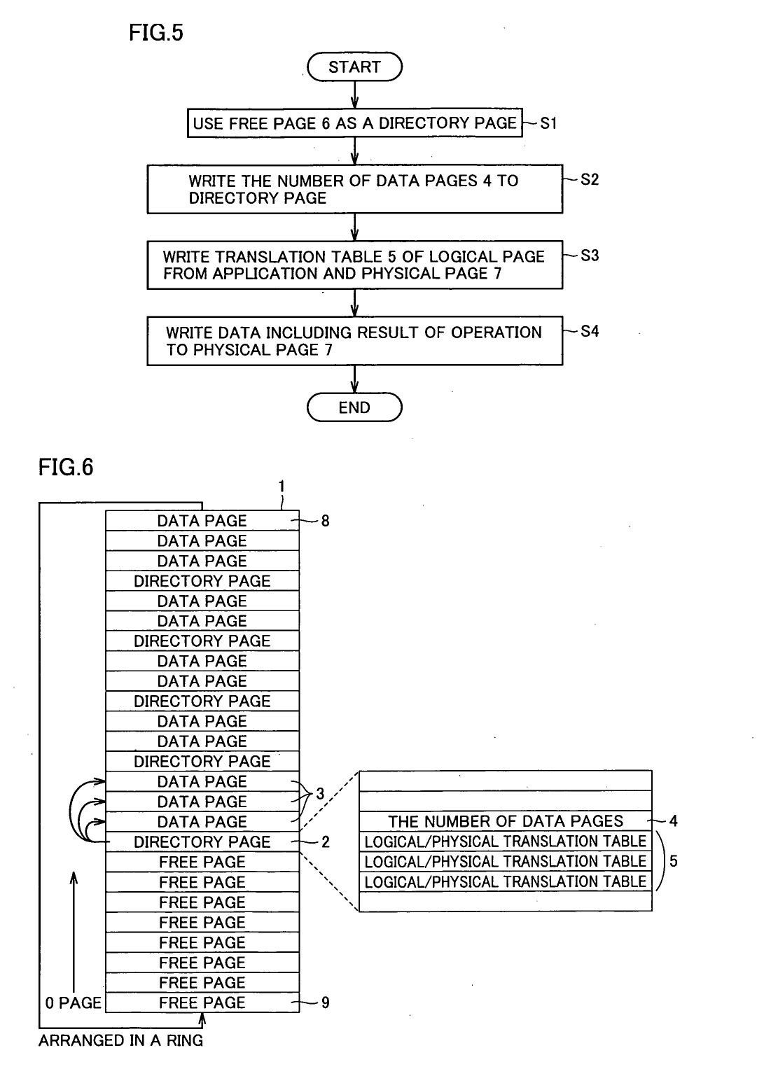

FIG. 6 shows an exemplary map of a non-volatile memory in accordance with the second embodiment of the present invention. Different from the map of the non-volatile memory in accordance with the first embodiment shown in FIG. 3, physical pages are arranged in a ring.

When the highest page 8 is not a free page, free page extracting unit 51′ returns to the lowest page 9 and continues extraction of a free page.

As the data written previously remain in the lowest sector, it is necessary to determine whether the data have been all updated and written in any other sector. As a method of determination, whether all the logical pages identical with those in the data pages of the lowest sector exist in any other sector or not is determined. When all exist in another sector, the lowest sector is erased and made a free sector. If the lowest sector can not be erased, whether the next sector is erasable or not is determined through the same method. By repeating this process, a free page is extracted.

As the physical pages are arranged in a ring in this manner, easy page management is possible even when data must be updated collectively and data have been already written up to the highest page 8.

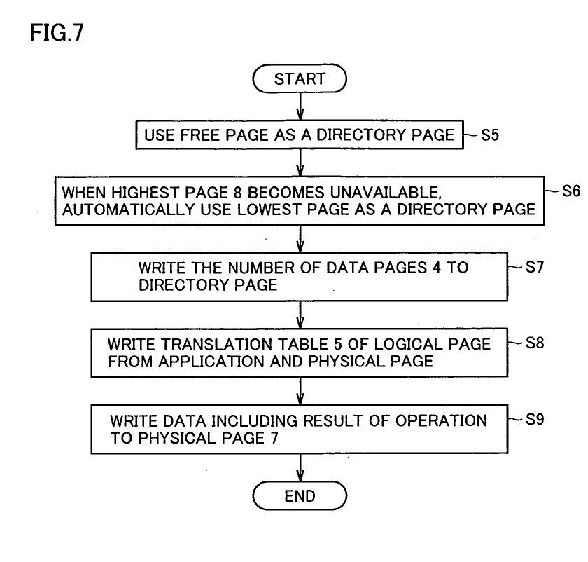

FIG. 7 is a flow chart representing process steps performed by the non-volatile memory control device in accordance with the second embodiment of the present invention. First, free page extracting unit 51′ extracts a free page and makes the same a directory page (S5). When the highest page 8 is not a free page, free page extracting unit 51′ returns to the lowest page 9 and extracts a free page (S6). In the example of FIG. 6, free page 9 serves as a directory page.

Thereafter, directory page writing unit 52 writes the number of data pages 4 to directory page 2 (S7). Then, directory page writing unit 52 writes to directory page 2 a logical/physical translation table 5 for translating a logical page number from an application to a physical page number (S8).

Finally, data page writing unit 53 writes contents of the data page including the result of operation starting from free page 7 that follows the directory page (S9), and the process is thus complete.

As described above, in the non-volatile memory control device in accordance with the present embodiment, when the highest page 8 is not a free page, free page extracting unit 51′ returns to the lowest page 9 to extract a free page. Therefore, in addition to the effect attained by the first embodiment, more effective use of a free area in the memory becomes possible.

(Third Embodiment)

Exemplary configuration of the non-volatile memory control device in accordance with the third embodiment of the present invention is similar to that of the non-volatile memory control device in accordance with the first embodiment shown in FIGS. 1 and 2. Therefore, detailed description of overlapping configuration and function will not be repeated.

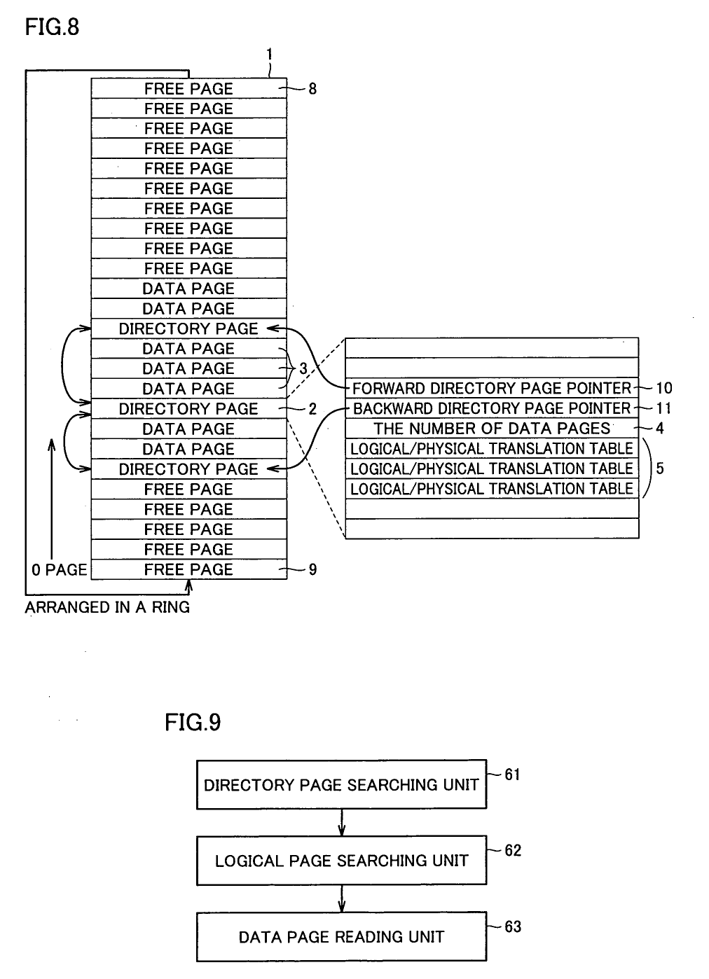

FIG. 8 shows an exemplary map of a non-volatile memory m accordance with the third embodiment of the present invention. Different from the map of the non-volatile memory in accordance with the second embodiment shown in FIG. 6, a forward directory page pointer 10 to which a pointer of a directory page to be newly written next is written and a backward directory page pointer 11 to which a pointer of a second latest directory page is written are additionally provided.

As the forward directory page pointer 10 and the backward directory page pointer 11 are provided, it becomes possible to link directories with each other to enable searching of a desired logical page. When there are a. plurality of logical/physical translation tables corresponding to the same logical page, a physical page number stored in the most recently written logical/physical translation table is regarded as a correct one.

FIG. 9 is a block diagram representing a functional configuration of a non-volatile memory control device in accordance with the third embodiment of the present invention. The non-volatile memory control device includes a directory page searching unit 61 referring to forward directory page pointer 10 and backward directory page pointer 11 to search for a directory page in non-volatile memory 1, a logical page searching unit 62 referring to the logical/physical translation table 5 searched out by directory page searching unit 61 to find a desired logical page, and a data page reading unit 63 reading data from a physical page that corresponds to the logical page searched out by logical page searching unit 62.

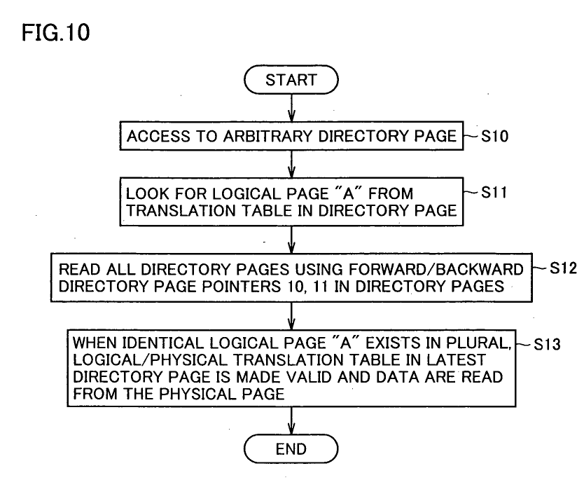

FIG. 10 is a flow chart representing process steps performed by the non-volatile memory control device in accordance with the third embodiment of the present invention. It is assumed that the non-volatile memory control device accesses to the non-volatile memory 1 at the time of initialization, and stores in RAM 42 or the like information related to already written pages. In the present embodiment, physical pages of non-volatile memory 1 are arranged in a ring, and therefore, it is necessary to obtain beforehand the information as to which page is a free page. For this purpose, at the time of initialization, all pages are accessed, and information related to already written pages is obtained. The information is used to extract a free page to. which data is to be written. In the following description, it is assumed that the non-volatile memory control device reads data from logical page “A” in response to a request from an application.

First, directory page searching unit 61 accesses to an arbitrary directory page and reads a logical/physical translation table 5 (S10). For instance, access starts from a directory page that has been most recently accessed. Logical page searching unit 62 refers to logical/physical translation table 5 in the directory page searched out by directory page searching unit 61, and determines whether the desired logical page “A” exists or not (S11). When logical page “A” exists, logical page searching unit 62 holds information related to a physical page corresponding to logical page “A”, in RAM 42 or the like.

Thereafter, directory page searching unit 61 refers to forward directory page pointer 10 and backward directory page pointer 11 to find the directory page to be searched next. Logical page searching unit 62 refers to logical/physical translation table 5 in the directory page searched by directory page searching unit 61, and determines whether the desired logical page “A” exists or not. By repeating this process, all directory pages are searched (S12).

When logical page “A” exists in a plurality of directory pages, data page reading unit 63 regards logical/physical translation table 5 in the latest directory page as valid, and reads information of the corresponding physical page from RAM 42. From the physical page, data are read and stored in RAM 42 (S13). As a new directory page can be extracted by making a reference to the forward directory page pointer 10, among the plurality of directory pages in which logical page “A” exists, one that is the latest and pointed by forward directory page pointer 10 serves as the latest directory page.

As described above, in the non-volatile memory control device in accordance with the present embodiment, whether a desired logical page exists or not among all the directories while making reference to forward directory page pointer 10 and backward directory page pointer 11, data of the latest logical page can readily be obtained even when the same logical page exists in a plurality of directory pages.

(Fourth Embodiment)

Exemplary configuration of the non-volatile memory control device in accordance with the fourth embodiment of the present invention is similar to that of the non-volatile memory control device in accordance with the first embodiment shown in FIGS. 1 and 2. Further, functional configuration of the non-volatile memory control device in accordance with the fourth embodiment differs from that of the non-volatile memory control device in accordance with the first embodiment shown in FIG. 4 only in the function of directory page writing unit 52. Therefore, detailed description of overlapping configuration and function will not be repeated. In the present embodiment, the directory page writing unit will be denoted by the reference character 52′.

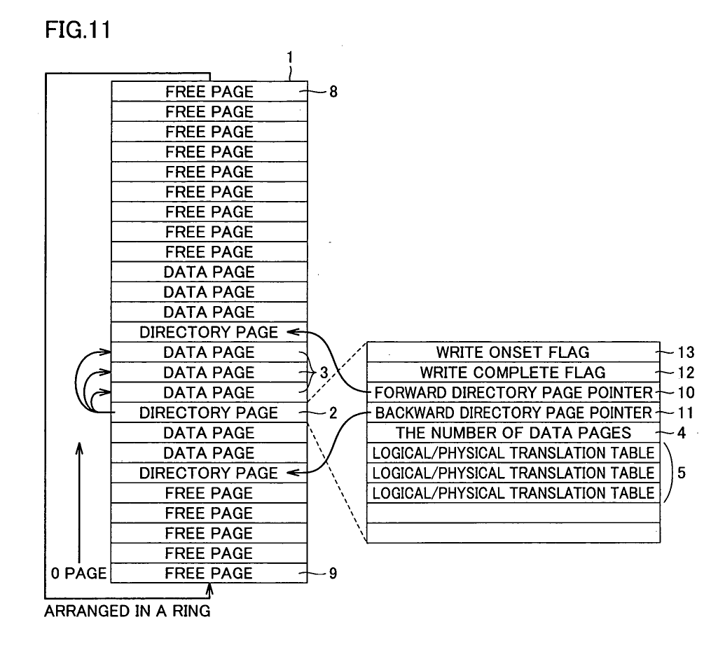

FIG. 11 shows an exemplary map of a non-volatile memory in accordance with the fourth embodiment of the present invention. It is different from the map of non-volatile memory in accordance with the third embodiment shown in FIG. 8 only in that a write complete flag 12 indicating whether data write to a data page is complete or not, and a write onset flag 13 indicating whether data write to the data page has been started or not are added.

Write onset flag 13 is set when data page writing unit 53 starts writing of data to the data page, after directory page writing unit 52′ has written data to the directory page. Write complete flag 12 is set when data page writing unit 53 has completed writing of data to the data page. Therefore, when write onset flag 13 in directory page 2 is set and write complete flag 12 is not set, process proceeds assuming that data write to the data page has been interrupted.

The process steps of the non-volatile memory control device in accordance with the fourth embodiment are the same as the process steps of the non-volatile memory control device in accordance with the second embodiment shown in FIG. 7 except for steps S8 and S9. Therefore, overlapping description will not be repeated. In the present embodiment, steps corresponding to S8 and S9 will be denoted by S8′ and S9′.

Directory page writing unit 52′ writes the number of data pages in directory page 2 (S7), writes logical/physical translation table 5, forward directory page pointer 10 and backward directory page pointer 11, and sets write onset flag 13 (S8′).

Thereafter, data page writing unit 53 writes contents of the data page including the result of operation and the like, starting from a free page following the directory page. When writing of data to the data page is complete, directory page writing unit 52′ sets write complete flag 12 (S9′), and the process is terminated.

If the write onset flag 13 is set and the write complete flag 12 is not set, it is determined that data could not be successfully written. Here, it is the case that writing to directory page 2 has been done, while data is not written to data page 3. Therefore, a page that has the data before updating written is searched by making a reference to the backward directory pointer 11, and data before updating can be read from the page. Further, by making a reference to the forward directory pointer 10, it is possible to write updated data to the new directory page and the data page.

As described above, according to the non-volatile memory control device of the present embodiment, as the write complete flag 12 and write onset flag 13 are set in accordance with the state of data writing, it becomes possible to readily confirm interruption of data writing by some cause, and hence, recovery of the data before updating is facilitated.

(Fifth Embodiment)

Exemplary configuration of the non-volatile memory control device in accordance with the fifth embodiment of the present invention is similar to that of the non-volatile memory control device in accordance with the first embodiment shown in FIGS. 1 and 2. Therefore, detailed description of overlapping configuration and function will not be repeated.

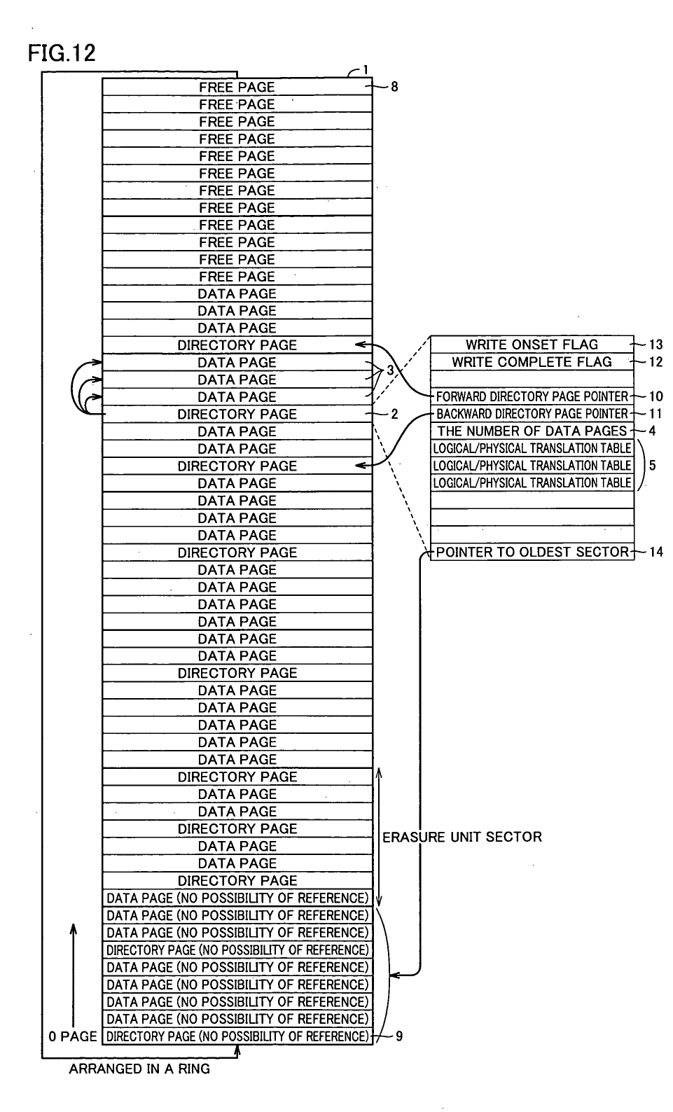

FIG. 12 shows an exemplary map of a non-volatile memory in accordance with the fifth embodiment of the present invention. Different from the map of the non-volatile memory in accordance with the fourth embodiment shown in FIG. 11, it additionally has a pointer 14 pointing an oldest sector. As the updated data are successively written to the free pages, free pages would be used up unless sectors that are no longer referred to are erased successively. A sector is erased, referring to the pointer 14 of the oldest sector 14. By making a reference to backward directory page pointer 11, a directory page that is older by one can be detected, and therefore, by means of the backward directory page pointer 11, older directory pages are successively detected, and the sector in which the oldest directory page exists is found to be the oldest sector. Pointer 14 of the oldest sector is written at the same timing as the writing of the number of data pages 4 and logical/physical translation table 5.

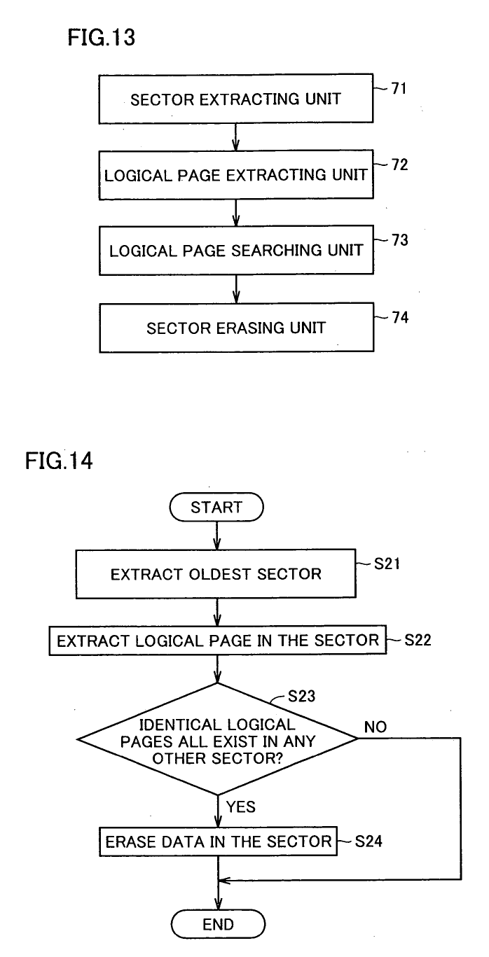

FIG. 13 is a block diagram representing a functional configuration of a non-volatile memory control device in accordance with the fifth embodiment of the present invention. The non-volatile memory control device includes a sector extracting unit 71 extracting an oldest sector, a logical page extracting unit 72 extracting a logical page included in the sector extracted by sector extracting unit 71, a logical page searching unit 73 searching whether or not the logical page extracted by logical page extracting unit 72 is included in any other sector, and a sector erasing unit 74 erasing the data in the oldest sector.

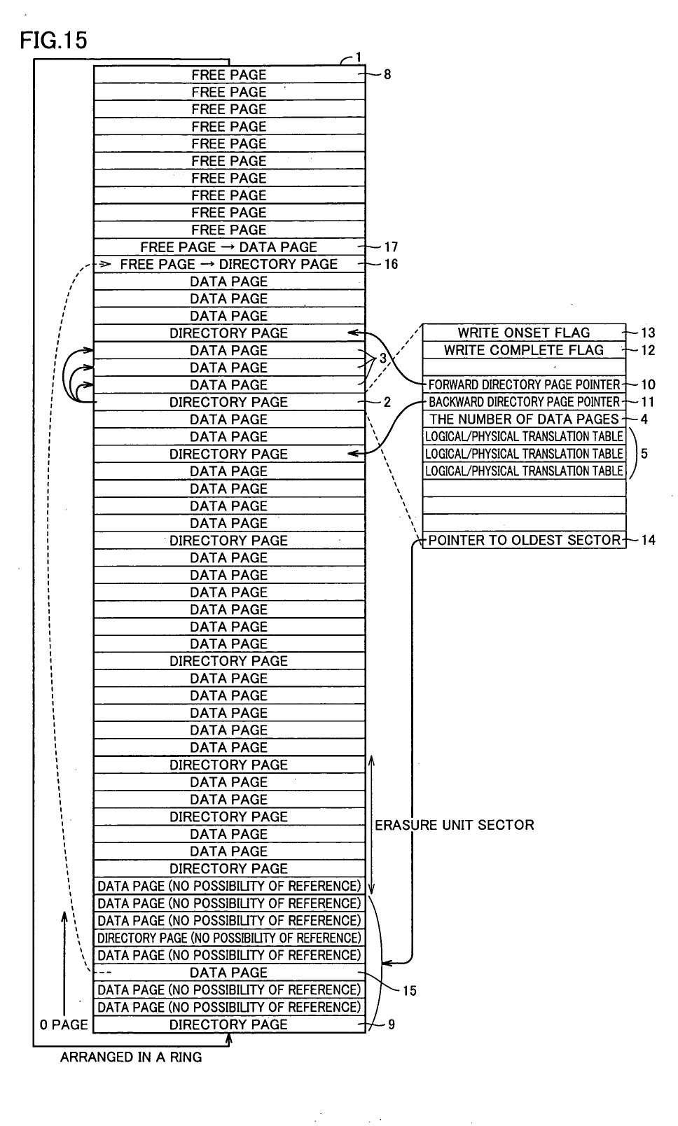

FIG. 14 is a flow chart representing process steps performed by the non-volatile memory control device in accordance with the fifth embodiment of the present invention. First, sector extracting unit 71 refers to the pointer 14 of the oldest sector in directory page 2 and extracts the oldest sector (S21). When there are a plurality of directory pages, pointer 14 pointing to the oldest sector may differ, and hence, pointer 14 of the oldest sector in the newest directory page is used. As the new directory can be detected by making a reference to forward directory page pointer 10, it is possible to detect the newest directory page by successively making a reference to forward directory page pointer 10.

Then, logical page extracting unit 73 extracts contents of logical/physical translation table 5 in directory page 2 in the sector extracted by sector extracting unit 71 (S22). Logical page searching unit 73 determines whether there are identical logical pages in any other sector .(S23).

When identical logical pages all exist in other sectors (S23, Yes), there is no possibility that the oldest sector will be referred to in the future, and therefore, sector erasing unit 74 erases the sector (S24). When the identical logical pages do not exist in any other sector (S23, No), the process ends without any further processing. When identical logical pages all exist in other sectors, there is no possibility that the oldest sector will be referred to in the future, and therefore, the sector may immediately be erased, or the sector may be erased when free pages are all used up.

As described above, in the non-volatile memory control device in accordance with the present embodiment, a sector having no possibility of being referred to is erased referring to the pointer of the oldest sector, and therefore, a free page can be ensured and capacity shortage of non-volatile memory 1 can be prevented.

(Sixth Embodiment)

Exemplary configuration of the non-volatile memory control device in accordance with the sixth embodiment of the present invention is similar to that of the non-volatile memory control device in accordance with the first embodiment shown in FIGS. 1 and 2. Therefore, detailed description of overlapping configuration and function will not be repeated.

FIG. 15 shows an exemplary map of a non-volatile memory in accordance with the sixth embodiment of the present invention. Different from the map of the non-volatile memory in accordance with the fifth embodiment shown in FIG. 12, when there is a data page 15 that may possibly be referred to in the oldest sector, the data page and the corresponding directory page 9 are copied to a free page or free pages.

In the fifth embodiment of the present invention, when at least one data page that may possibly be referred to exists in the oldest sector, the sector is not erased. Therefore, it may be impossible to ensure a free page. In the present embodiment, when there is a data page that may possibly be referred to in the future in the oldest sector, the data page and the corresponding directory page are copied to free pages, and thereafter, the sector is erased. When a logical page identical with that of the data page in the oldest sector exists in any other sector, the data page is determined to be a data page that has no possibility of being referred to in the future. When a logical page identical with that of the data page in the oldest sector does not exist in any other sector, the data page is determined to be a data page that may possibly be referred to in the future.

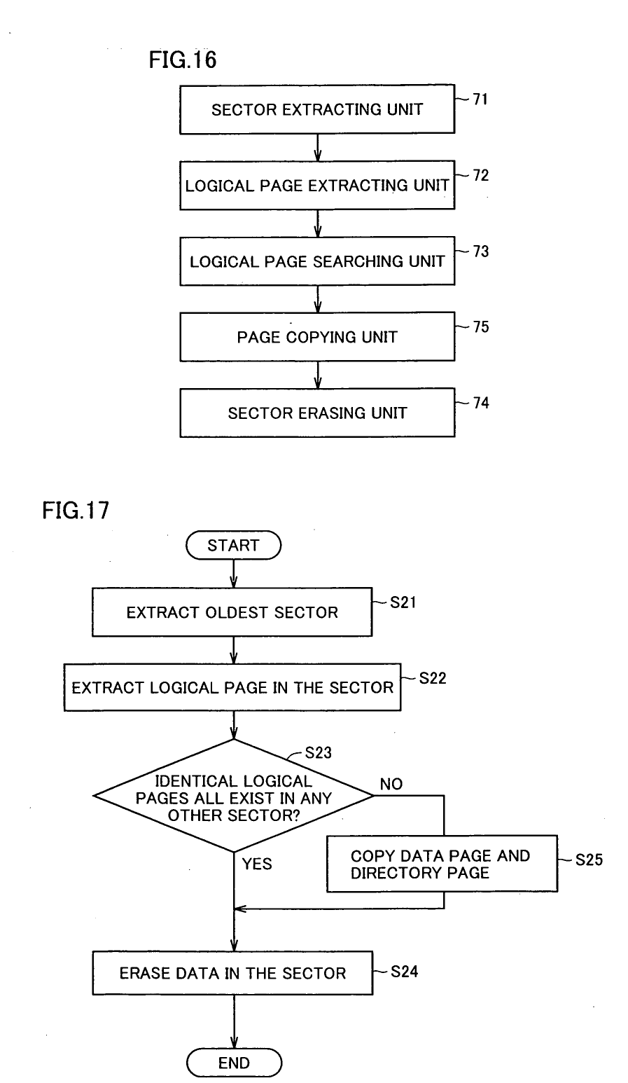

FIG. 16 is a block diagram representing a functional configuration of a non-volatile memory control device in accordance with the sixth embodiment of the present invention. The functional configuration is the same as that of the non-volatile memory control device in accordance with the fifth embodiment shown in FIG. 13 except that a page copying unit 75 is added for copying the data page and the corresponding directory page to the free pages. Therefore, detailed description of overlapping configuration and function will not be repeated.

FIG. 17 is a flow chart representing process steps performed by the non-volatile memory control device in accordance with the sixth embodiment of the present invention. The process steps are the same as the process steps of the non-volatile memory control device in accordance with the fifth embodiment shown in FIG. 14 except that step S25 is added. Therefore, detailed description of overlapping process steps will not be repeated.

When the identical logical pages do not exist in any other sector (S23, No), page copying unit 75 copies the data page 15 and the corresponding directory page 9 to free pages 16 and 17 (S25). Then, sector erasing unit 74 erases the data of the oldest sector (S24), and the process is terminated.

As described above, in the non-volatile memory control device in accordance with the present embodiment, when a data page that may possibly be referred to exists in the oldest sector, the data page and the directory page corresponding thereto are copied to free pages, and the sector is erased thereafter. Thus, a free page can be ensured with higher reliability than in the fifth embodiment, and capacity shortage of non-volatile memory 1 can be prevented.

(Seventh Embodiment)

Exemplary configuration of the non-volatile memory control device in accordance with the seventh embodiment of the present invention is similar to that of the non-volatile memory control device in accordance with the first embodiment shown in FIGS. 1 and 2. Further, functional configuration of the non-volatile memory control device in accordance with the seventh embodiment differs from that of the non-volatile memory control device in accordance with the first embodiment shown in FIG. 3 only in the function of directory page writing unit 52. Therefore, detailed description of overlapping configuration and function will not be repeated. In the present embodiment, the directory page writing unit will be denoted .by the reference character 52″.

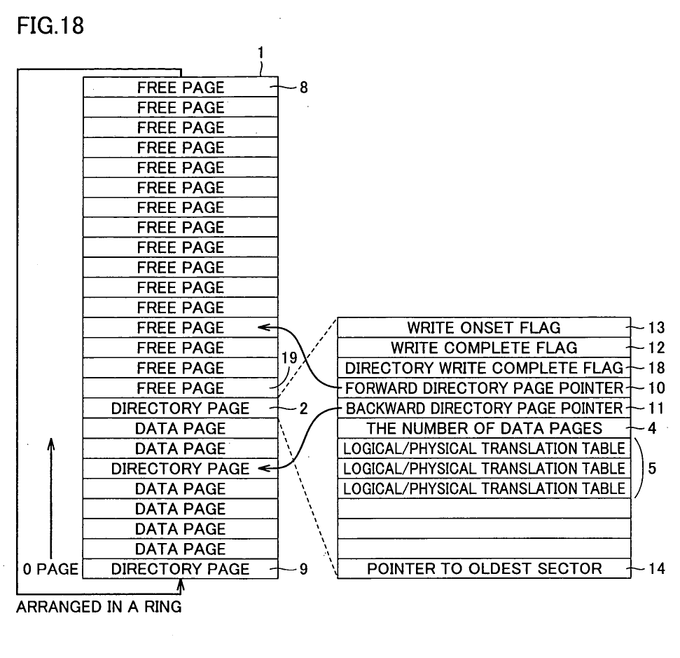

FIG. 18 shows an exemplary map of a non-volatile memory in accordance with the seventh embodiment of the present invention. Different from the map of the non-volatile memory in accordance with the fourth embodiment shown in FIG. 11, it additionally has a directory write complete flag 18 indicating whether the directory writing to directory page 2 has been complete or not.

Directory write complete flag 18 is set when directory page writing unit 52″ has written information other than the write complete flag 12 and write onset flag 13 in the directory page. When the directory write complete flag 18 is not set, it is determined that directory writing to directory page 2 has been interrupted.

When the directory write complete flag 18 is not set, the directory page is considered invalid, and the contents of the directory page are again written to the next free page 19.

As described above, in the non-volatile memory control device in accordance with the present embodiment, directory write complete flag 18 is set in accordance with the state of writing to the directory page. Therefore, it becomes possible to readily confirm interruption of directory writing to the directory page by some cause, and hence, rewriting of directory page is facilitated.

(Eighth Embodiment)

Exemplary configuration of the non-volatile memory control device in accordance with the eighth embodiment of the present invention is similar to that of the non-volatile memory control device in accordance with the first embodiment shown in FIGS. 1 and 2. Further, functional configuration of the non-volatile memory control device in accordance with the eighth embodiment differs from that of the non-volatile memory control device in accordance with the fifth embodiment shown in FIG. 13 only in the function of sector erasing unit 74. Therefore, detailed description of overlapping configuration and function will not be repeated. In the present embodiment, the sector erasing unit will be denoted by the reference character 74′.

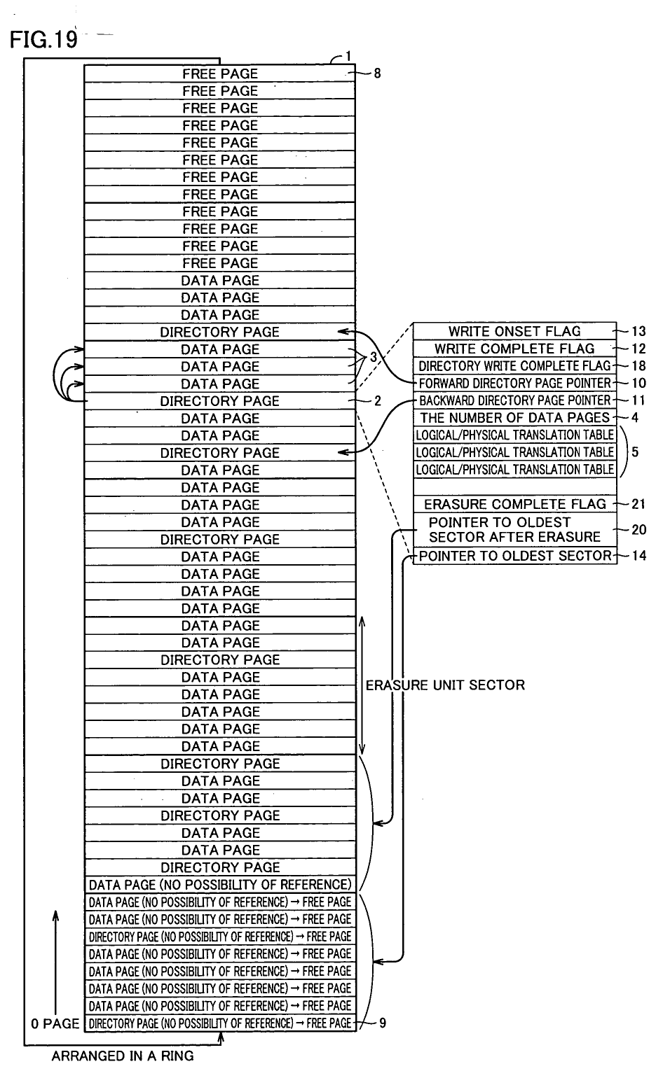

FIG. 19 shows an exemplary map of a non-volatile memory in accordance with the eighth embodiment of the present invention. Different from the map of the non-volatile memory in accordance with the seventh embodiment shown in FIG. 18, it additionally has a pointer indicating the sector that will be the oldest next when a sector is erased, and an erasure complete flag 21 indicating completion of sector erasure without any interruption.

When sector erasing unit 74′ erases the oldest sector, it writes to the directory page the pointer 20 of that sector which will be the oldest after the erasure of the oldest sector. When sector erasure is not interrupted, sector erasing unit 74′ sets the erasure complete flag 21.

When a new directory is generated, the erasure complete flag 21 is referred to, and when the erasure complete flag 21 is set, the contents of pointer 20 of the oldest sector after erasure are written to the pointer 14 of the oldest sector in the new directory.

As described above, in the non-volatile memory control device in accordance with the present embodiment, erasure complete flag 21 is provided in the directory page, and therefore, it becomes easier to confirm whether erasure is successfully completed or not.

Further, as the pointer of the oldest sector after erasure is provided, it becomes easier to determine the oldest sector when a new directory is generated.

(Ninth Embodiment)

Exemplary configuration of the non-volatile memory control device in accordance with the ninth embodiment of the present invention is similar to that of the non-volatile memory control device in accordance with the first embodiment shown in FIGS. 1 and 2. Further, functional configuration of the non-volatile memory control device in accordance with the ninth embodiment differs from that of the non-volatile memory control device in accordance with the third embodiment shown in FIG. 9 only in the function of directory page searching unit 61. Therefore, detailed description of overlapping configuration and function will not be repeated. In the present embodiment, the directory page searching unit will be denoted by the reference character 61′.

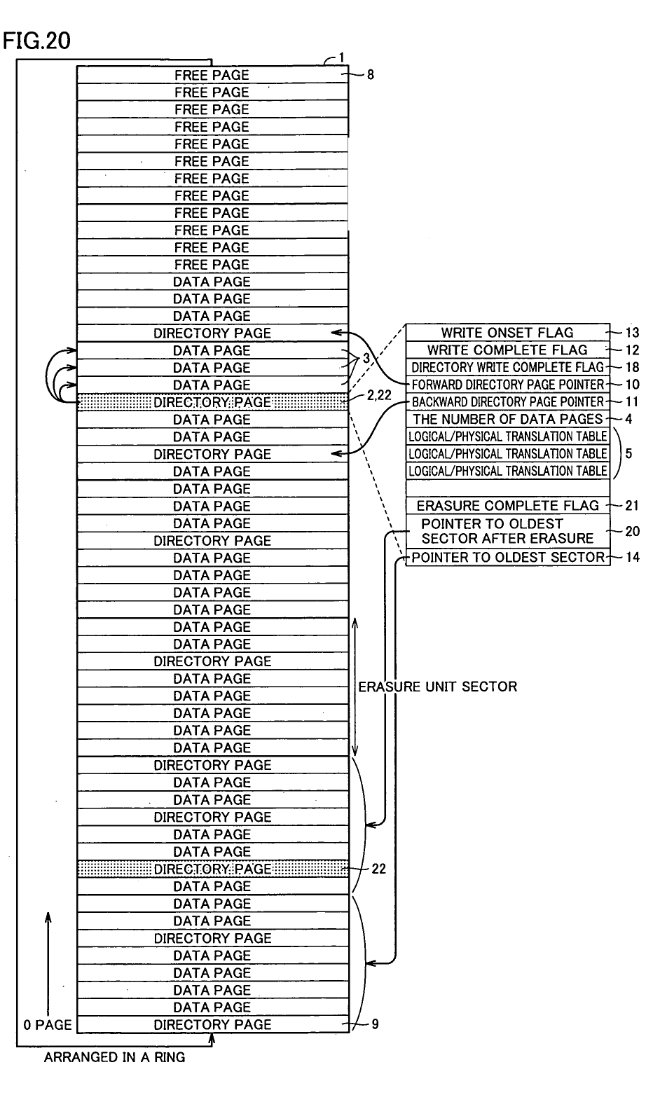

FIG. 20 shows an exemplary map of a non-volatile memory in accordance with the ninth embodiment of the present invention. Different from the map of the non-volatile memory in accordance with the eighth embodiment shown in FIG. 19, it differs only in that a fixed page 22 in a plurality of sectors is certainly made to serve as the directory page. Even when one of the plurality of fixed directory pages is erased, at least one fixed page 22 is left, so as to be used as a clue for searching a directory page.

At the time of initialization, when non-volatile memory 1 is accessed and information related to already written pages is to be stored in RAM 42, directory page searching unit 61′ searches for the fixed directory page 22. Logical page searching unit 62 refers to the logical/physical translation table 5 in the fixed directory page 22 searched out by directory page searching unit 61′, and determines whether a desired logical page exists or not. When the desired logical page exists, logical page searching unit 63 holds information of a physical page corresponding to the desired logical page in RAM 42 or the like.

Then, directory page searching unit 61′ refers to forward directory page pointer 10 to find a directory page to be searched next. Logical page searching unit 62 refers to logical/physical translation table 5 in the fixed directory page 22 searched out by directory page searching unit 61′ to determine whether the desired logical page exists or not. By repeating this operation, search is continued to the latest directory page.

When the desired logical page exists in a plurality of directory pages, data page reading unit 63 makes valid the logical/physical translation table 5 in the latest directory page, and reads the corresponding physical page from RAM 42 or the like. Then, data are read from the physical page and stored in RAM 42 or the like.

As described above, in the non-volatile memory control device in accordance with the present embodiment, a fixed page 22 in a plurality of sectors is surely made a directory page, and therefore, a problem that all the directory pages are erased and search for a data page becomes impossible can be prevented.

(Tenth Embodiment)

Exemplary configuration of the non-volatile memory control device in accordance with the tenth embodiment of the present invention is similar to that of the non-volatile memory control device in accordance with the first embodiment shown in FIGS. 1 and 2. Therefore, detailed description of overlapping configuration and function will not be repeated.

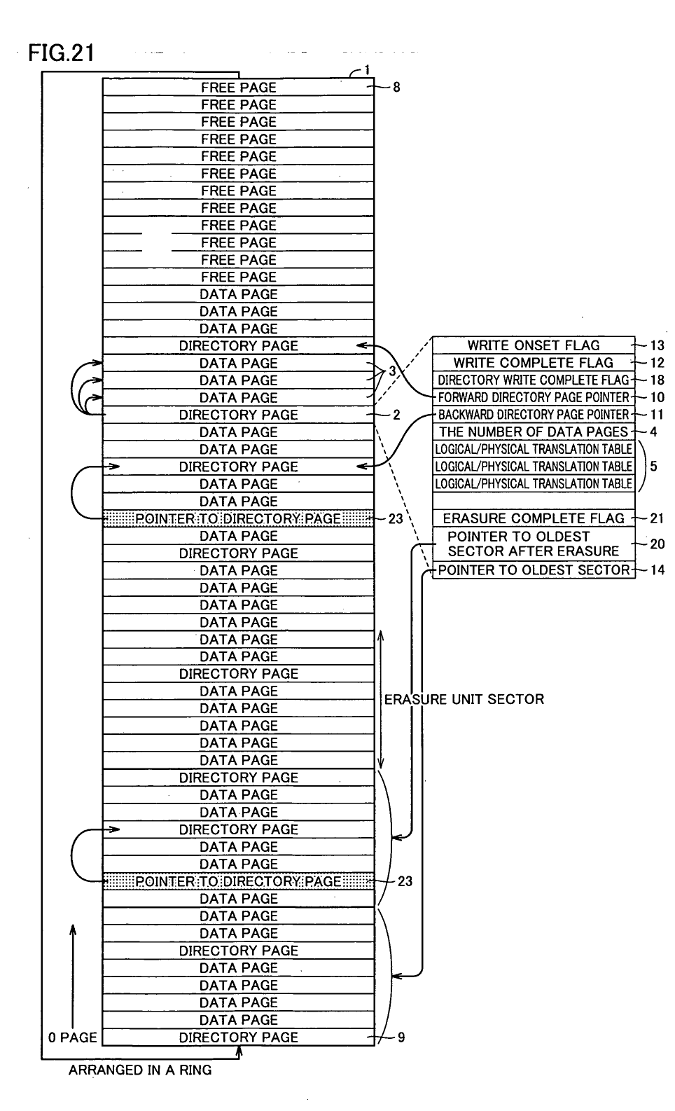

FIG. 21 shows an exemplary map of a non-volatile memory in accordance with the tenth embodiment of the present invention. It is the same as the map of the non-volatile memory in accordance with the ninth embodiment shown in FIG. 20, except that a fixed page 23 in a plurality of sectors is surely used as a pointer to the next directory page. Even when any pointer 23 to a plurality of directory pages should be erased, at least a pointer 23 to one directory page is left, to be used as a clue for searching the directory page.

In the ninth embodiment, fixed page 22 is used as the directory page, and therefore, when data are written up to the page immediately preceding fixed directory page 22 and the data should continuously be written, the data must be written skipping the fixed directory page 22. This possibly makes it difficult to search for the directory page.

In the present embodiment, the fixed directory page 23 is used as a pointer to the next directory page, so as to facilitate searching of the directory page. Specifically, when data pages are written up to the fixed page 23, data writing is continued from the page next to the fixed page 23. When data page writing is complete, information indicating the page immediately following the last written data page is written to the fixed page 23, so that the fixed page comes to serve as a pointer to the next directory page.

As described above, in the non-volatile memory control device in accordance with the present embodiment, a fixed page is used as a pointer to the next directory page. Therefore, in addition to the effects attained by the ninth embodiment, a further advantage is attained that search for a directory page is further facilitated.

(Eleventh Embodiment)

Exemplary configuration of the non-volatile memory control device in accordance with the eleventh embodiment of the present invention is similar to that of the non-volatile memory control device in accordance with the first embodiment shown in FIGS. 1 and 2. Therefore, detailed description of overlapping configuration and function will not be repeated.

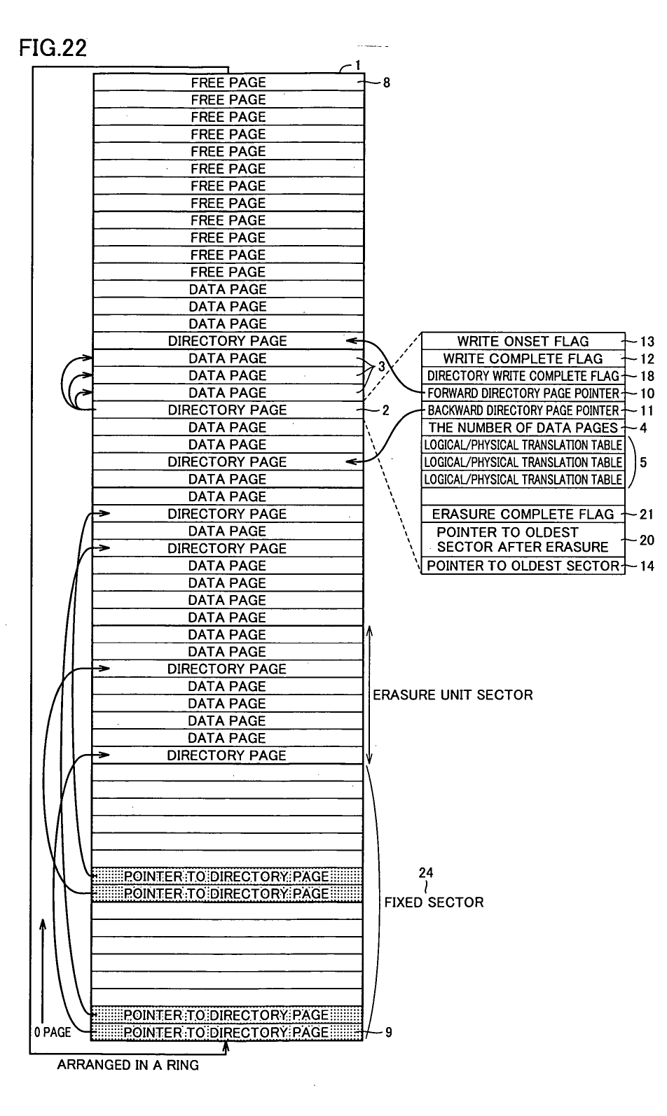

FIG. 22 shows an exemplary map of a non-volatile memory in accordance with the eleventh embodiment of the present invention. Different from the map of the non-volatile memory in accordance with the tenth embodiment shown in FIG. 21, pointers to a plurality of directory pages are additionally written to a fixed sector 24.

In the present embodiment, pointers to a plurality of directory pages are added to a fixed sector 24, so as to further facilitate the search for the directory page. Specifically, when writing of data pages is complete, a pointer to the next page is additionally written to the fixed sector 24, so that the fixed sector comes to serve as a pointer to the next directory page.

As described above, in the non-volatile memory control device in accordance with the present embodiment, pointers to directory pages are additionally written to the fixed page 24. Therefore, in addition to the effects described with reference to the tenth embodiment, a further advantage is attained that by simply searching through the fixed sector 24, directory pages can be searched, and hence the search for the directory pages is facilitated.

(Twelfth Embodiment)

Exemplary configuration of the non-volatile memory control device in accordance with the twelfth embodiment of the present invention is similar to that of the non-volatile memory control device in accordance with the first embodiment shown in FIGS. 1 and 2. Further, functional configuration of the non-volatile memory control device in accordance with the twelfth embodiment differs from that of the non-volatile memory control device in accordance with the fourth embodiment only in the function of data page writing unit 53. Therefore, detailed description of overlapping configuration and function will not be repeated. In the present embodiment, the data page writing unit will be denoted by the reference character 53′.

The map of the non-volatile memory in accordance with the twelfth embodiment is the same as that of the fourth embodiment of the present invention.

The process steps of the non-volatile memory control device in accordance with the twelfth embodiment are the same as the process steps of the non-volatile memory control device in accordance with the fourth embodiment except for step S9′. Therefore, overlapping description will not be repeated. In the present embodiment, the step corresponding to S9′ will be denoted by S9″.

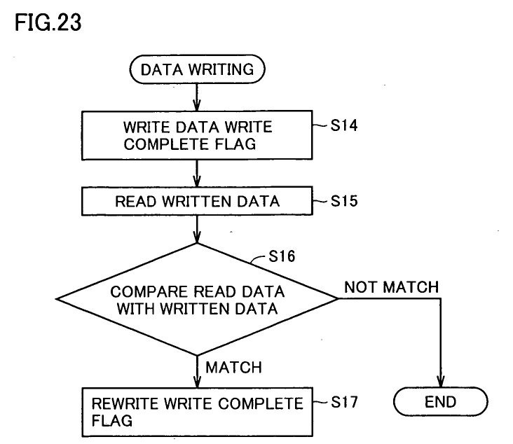

FIG. 23 is a flow chart representing, in detail, the process of step S9″ by a non-volatile memory control device in accordance with the twelfth embodiment of the present invention. When writing of data pages by data page writing unit 53′ is complete, directory page writing unit 52′ sets write complete flag 12 (S14).

Thereafter, data page writing unit 53′ reads the data written to the data pages (S15), and compares the read data with the written data (S16). When the read data and the written data do not match (S16, not match), the process is terminated. When the read data and the written data match (S16, match), write complete flag is rewritten (S17).

As described above, in the non-volatile memory control device in accordance with the present embodiment, write complete flag 12 is set when the writing of the data pages is complete, matching of the read data and the written data is confirmed, and the write complete flag 12 is rewritten. Therefore, even when there is an interruption after the end of writing data pages and before confirmation of matching between the read data and the written data, a problem that, though data writing has been successfully finished, write complete flag is not set, can be prevented.

Although the present invention has been described and illustrated in detail, it is clearly understood that the same is by way of illustration and example only and is not to be taken by way of limitation, the spirit and scope of the present invention being limited only by the terms of the appended claims.

1. A non-volatile memory control device for controlling a non-volatile memory in which data are erased sector by sector and data are written page by page, comprising:
an extracting unit extracting a free page of said non-volatile memory;
a first writing unit writing, to the free page extracted by said extracting unit, a directory including a table for translating a logical page number of a page, to which updated data are to be written, to a physical page number; and
a second writing unit writing said updated data to the free page extracted by said extracting unit.

2. The non-volatile memory control device according to claim 1, wherein
said non-volatile memory has pages arranged in a ring; and
said extracting unit extracts a free page starting from a lowest page, when a highest page is not a free page.

3. The non-volatile memory control device according to claim 1, wherein
said directory further includes a first pointer indicating a directory page to be newly written next and a second pointer indicating a second latest directory page.

4. The non-volatile memory control device according to claim 1, wherein
said directory further includes first and second flags;
said first writing unit sets said first flag when writing to a directory page is complete; and
said second writing unit sets said second flag when writing of a data page is complete.

5. The non-volatile memory control device according to claim 4, wherein
said second writing unit reads said written data, and when the written data matches the read data, rewrites said first flag.

6. The non-volatile memory control device according to claim 1, wherein
said directory further includes a third pointer indicating an oldest sector.

7. The non-volatile memory control device according to claim 6, wherein
said directory further includes a fourth pointer indicating a sector that becomes the oldest when the oldest sector is erased.

8. The non-volatile memory control device according to claim 1, wherein
said directory further includes a third flag; and
said first writing unit sets said third flag when writing to said directory page is complete.

9. The non-volatile memory control device according to claim 1, wherein
a directory page is set in a fixed page of a plurality of sectors of said non-volatile memory.

10. The non-volatile memory control device according to claim 1, wherein
a fifth pointer indicating a next directory page is stored in a fixed page of a plurality of sectors of said non-volatile memory.

11. The non-volatile memory control device according to claim 1, wherein
said first writing unit successively writes a sixth pointer indicating said table in a fixed sector of said non-volatile memory.

12. A non-volatile memory control device for controlling a non-volatile memory in which data are erased sector by sector and data are written page by page, comprising:
a first searching unit searching for a directory page including a table for translating a logical page number of a page, to which updated data are to be written, to a physical page number, a first pointer pointing a directory page to be newly written to, and a second pointer pointing a second latest directory page, and successively searching through directory pages based on the first and second pointers included in the directory pages;
a second searching unit referring to the table in the directory page searched out by said first searching unit and searching whether a desired logical page is contained or not; and
a reading unit reading, when the second searching unit searched out a plurality of desired logical pages, data from a physical page that corresponds to the logical page included in the latest table.

13. A non-volatile memory control device for controlling a non-volatile memory in which data are erased sector by sector and data are written page by page, comprising:
an extracting unit referring to a directory page including a table for translating a logical page number of a page, to which updated data are to be written, to a physical page number and a pointer pointing the oldest sector and extracting a logical page included in the oldest sector;
a searching unit searching whether a logical page identical with the logical page extracted by the extracting unit is included in any other sector; and
an erasing unit erasing said oldest sector, when it is determined by said searching unit that identical logical pages are all included in other sectors.

14. The non-volatile memory control device according to claim 13, further comprising
a copying unit copying, when said searching unit determines that an identical logical page does not exist in any other sector, said logical page and corresponding directory page to a free page; and
said erasing unit erases said oldest sector after copying by said copying unit is complete.
